(19) United States
(12) Patent Application Publication
(10) Pub. No.: US 2002/0138657 A1
(43) Pub. Date: Sep. 26, 2002

(54) Data transfer circuit and data transfer method

(75) Inventor: Masayuki Hirofuji, Tokyo (JP)

Correspondence Address: DARBY & DARBY P.C., 805 Third Avenue, New York, NY, 10022, US

(73) Assignee: Ando Electric Co., Ltd.

(21) Appl. No.: 10/104,411

(22) Filed: Mar. 22, 2002

(30) Foreign Application Priority Data
Mar. 26, 2001 (JP) P2001-088559

(51) Int. Cl. G06F 15/16

(52) U.S. Cl. 709/253

(57) ABSTRACT

A data transfer circuit and a data transfer method are provided that can minimize the time required for transferring identical data to a plurality of data registers. A data transfer circuit for writing parallel data transferred through a data bus into a plurality of data registers is provided with auxiliary registers which respectively correspond to the data registers, a write timing determining section, and an auxiliary register setting section. At a first timing, the auxiliary register setting section makes the auxiliary registers store the respective bit values of parallel data transferred through the data bus. At a second timing, after the first timing, the write timing determining section makes the data registers store another parallel data transferred through the data bus in accordance with the respective bit values stored in the auxiliary registers.

### BACKGROUND OF THE INVENTION

1. Field of the Invention

The present invention relates to a data transfer circuit and a data transfer method that can minimize the time required for transferring data to data registers.

2. Description of the Related Art

FIG. 5 is a block diagram showing the structure of one of the circuit blocks 300-x (x=1, 2, . . . , n, and n is an integer greater than one) constituting a conventional data transfer circuit. Each circuit block 300-x is provided with a data register 20 which stores data transferred through a data bus 14, and a write AND gate 30 which supplies a write clock 16 to the data register 20.

The write AND gate 30 receives a write signal 11 and a write address signal 13, the waveforms of which are shown in FIG. 6, and computes the logical product of these two signals to output the resultant signal as the write clock 16. In response to receipt of the write clock 16, the data register 20 stores parallel data (a plurality of bits) that are transferred through the data bus 14. The data register 20 then outputs the stored parallel data (the plurality of bits) to the outside of each circuit block 300-x.

The number of bits of the data stored in the data register 20 is less than or equal to the width (the number of bits) of the data bus 14. However, in order to simplify the explanation, it is assumed that the number of bits of the data stored in the data register 20 is equal to the width (the number of bits) of the data bus 14, both of which are 32 bits.

FIG. 7 is a block diagram showing the overall structure of a conventional data transfer circuit 350. The data transfer circuit 350 is provided with n (n is an integer greater than one) circuit blocks 300-1, 300-2, . . . , and 300-n, whose outputs are supplied to n (n is an integer greater than one) drivers 103-1, 103-2, . . . , and 103-n, respectively. The outputs of the drivers 103-1, 103-2, . . . , and 103-n are connected, for example, to test pins (not shown in the figures) of a semiconductor testing apparatus (not shown in the figures), and these test pins supply test signals to a semiconductor device under test (not shown in the figures) mounted in the semiconductor testing apparatus.

A CPU (Central Processing Unit) 101, which controls the overall operation of a system such as a semiconductor testing apparatus, is connected to the data bus 14. The CPU 101 outputs 32 bit parallel data to the data bus 14. The data bus 14 is connected to the data registers 20 provided in the circuit blocks 300-1, 300-2, . . . , and 300-n. That is, each of the data registers 20 provided in the circuit blocks 300-1, 300-2, . . . , and 300-n receives 32 bit parallel data through the data bus 14.

The CPU 101 is also connected to an address bus 19 to output an address to the address bus 19. An address transferred through the address bus 19 is supplied to a decoder 102, which converts the address thus supplied into the write address signals 13. That is, the decoder 102 outputs a write address signal 13 or alternatively outputs no write address signal 13, depending on the supplied address. The write address signals 13 are supplied to the write AND gates 30 provided in the circuit blocks 300-1, 300-2, . . . , and 300-n, respectively.

In addition, the CPU 101 outputs the write signal 11 for directing the data registers 20 to store data therein. The write signal 11 is commonly supplied to the entire write AND gates 30 provided in the circuit blocks 300-1, 300-2, . . . , and 300-n.

Next, the operation of the data transfer circuit 350 will be explained. First, the CPU 101 outputs the address specifying the circuit block 300-1 to the address bus 19. The output address is supplied to the decoder 102, and the decoder 102 outputs a write address signal 13 to the circuit block 300-1 only.

When the CPU 101 outputs the address specifying the circuit block 300-1 to the address bus 19, the CPU 101 simultaneously outputs 32 bit parallel data, which is to be written into the data register 20 provided in the circuit block 300-1, to the data bus 14.

The CPU 101 then outputs a pulse as the write signal 11. The pulse of the write signal 11 is supplied to the write AND gate 30 provided in the circuit block 300-1. As a result, the write AND gate 30 outputs the write clock 16 to the data register 20. In response to the write clock 16, the data register 20 stores the 32 bit parallel data transferred from the CPU 101 through the data bus 14.

The above-described operation is repeated for each of the circuit blocks 300-2 through 300-n. Consequently, the 32 bit parallel data is stored in the respective data registers 20 provided in the circuit blocks 300-1, 300-2, . . . , and 300-n. The 32 bit parallel data stored in the data registers 20 are then transferred to the corresponding drivers 103-1, 103-2, . . . , and 103-n. The drivers 103-1, 103-2, . . . , and 103-n supply signals to test pins of a semiconductor testing apparatus in order to test a semiconductor device mounted in the semiconductor testing apparatus.

According to the aforementioned related art, when n circuit blocks are provided, it is necessary to provide n write address signals 13. In addition, even if identical data is transferred to the data registers 20 provided in the circuit blocks, it is necessary to perform data transfer through the data bus 14 the same number of times as the number of the data registers 20. As a result, the scale of a system and the time required for data transfer increase in proportion to the number of data registers 20.

### SUMMARY OF THE INVENTION

It is therefore an object of the present invention to provide a data transfer circuit and a data transfer method that can minimize the time required for data transfer even if identical data is transferred to a plurality of data registers.

A first aspect of the present invention is a data transfer circuit for transferring first parallel data transferred through a data bus to a plurality of data registers, comprising: a plurality of auxiliary registers, each of which corresponds to each of the data registers and stores a bit value indicating whether the first parallel data transferred through the data bus is to be stored in the corresponding data register; an auxiliary register setting section which writes, at a first timing, the respective bit values of second parallel data transferred through the data bus that correspond to the respective auxiliary registers into the respective auxiliary registers; and a write timing determining section which writes, at a second timing, after the first timing, the first parallel data transferred through the data bus into data registers corresponding to auxiliary registers, each of which stores a bit value indicating that the first parallel data is to be stored in the corresponding data register.

In the first aspect of the present invention, the data registers may be divided into a plurality of block cells, and the auxiliary register setting section may determine whether to write the respective bit values of the second parallel data into the respective auxiliary registers for each block cell.

A second aspect of the present invention is a data transfer method for transferring first parallel data transferred through a data bus to a plurality of data registers, comprising the steps of: a first step for writing, at a first timing, the respective bit values of second parallel data, which is transferred through the data bus and indicates whether the first parallel data is to be stored in the data registers, into a plurality of auxiliary registers corresponding to the respective data registers; and a second step for writing, at a second timing, after the first timing, the first parallel data transferred through the data bus into data registers corresponding to auxiliary registers, each of which stores a bit value indicating that the first parallel data is to be stored in the corresponding data register, by means of a write timing determining section.

In the second aspect of the present invention, the data registers may be divided into a plurality of block cells, and the first step may determine whether to write the respective bit values of the second parallel data into the respective auxiliary registers for each block cell.

According to the present invention, it is possible to transfer identical parallel data to a plurality of data registers simultaneously, thereby minimizing the time required for data transfer. In addition, it is possible to simultaneously transfer identical parallel data to a plurality of block cells.

### BRIEF DESCRIPTION OF THE DRAWINGS

FIG. 1 is a block diagram showing the structure of one of circuit blocks 100-x constituting a data transfer circuit according to a first embodiment of the present invention.

FIG. 2 is a block diagram showing the overall structure of a data transfer circuit 150 according to the first embodiment of the present invention.

FIG. 3 is a block diagram showing the structure of one of circuit blocks 200-m-x constituting a data transfer circuit according to a second embodiment of the present invention.

FIG. 4 is a block diagram showing the overall structure of a data transfer circuit 250 according to the second embodiment of the present invention.

FIG. 5 is a block diagram showing the structure of one of circuit blocks 300-x constituting a conventional data transfer circuit.

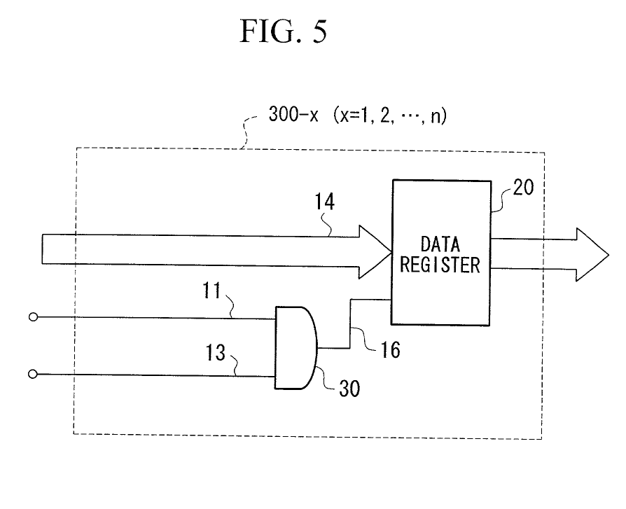

FIG. 6 is a timing chart showing the operation of the circuit blocks 300-x constituting the conventional data transfer circuit.

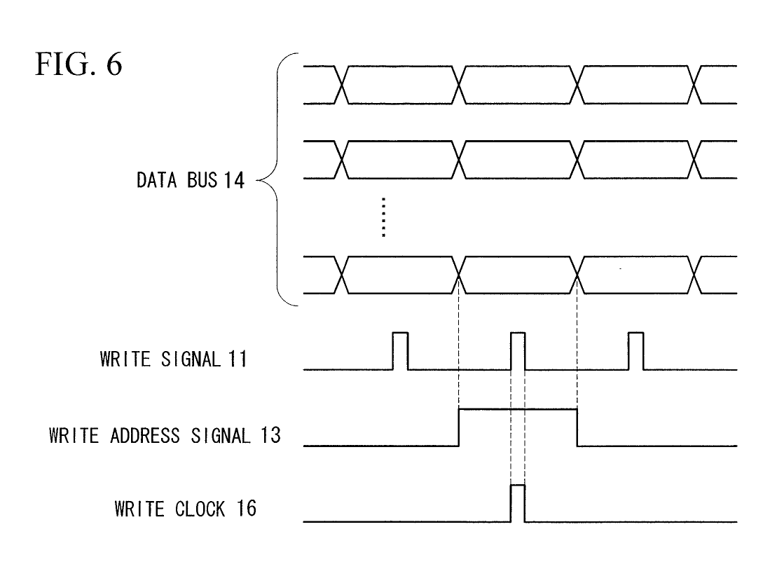

FIG. 7 is a block diagram showing the overall structure of a conventional data transfer circuit 350.

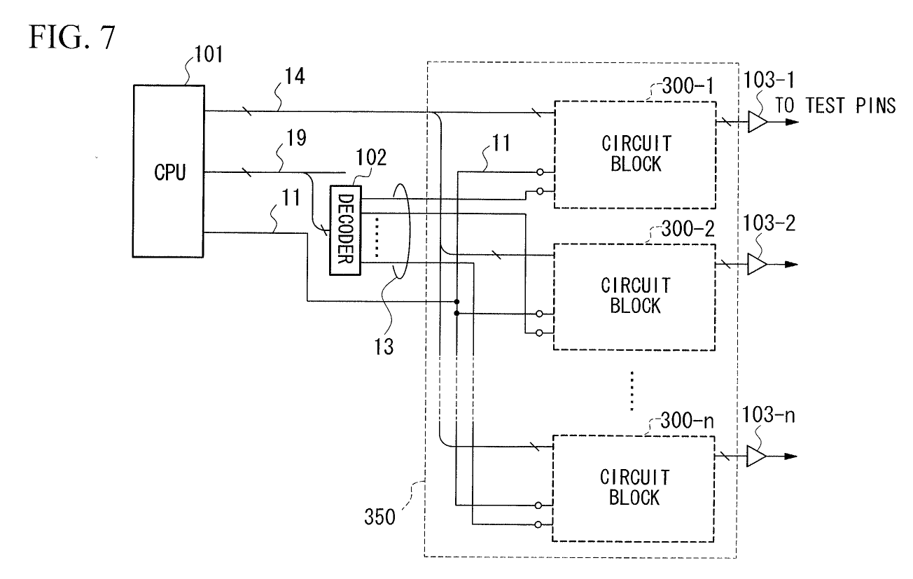

### DETAILED DESCRIPTION OF THE PREFERRED EMBODIMENTS

First Embodiment

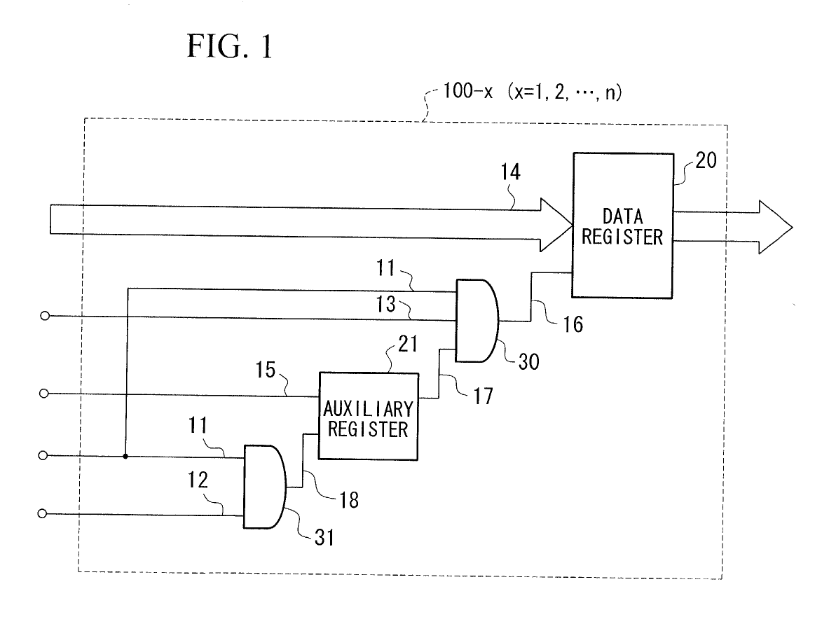

FIG. 1 is a block diagram showing the structure of one of circuit blocks 100-x (x=1, 2, . . . , n, and n is an integer greater than one) constituting a data transfer circuit according to a first embodiment of the present invention. The circuit block 100-x is provided with a data register 20 which stores data transferred through a data bus 14, a write AND gate 30 which supplies a write clock 16 to the data register 20, an auxiliary register 21 which supplies a gate signal 17 to the write AND gate 30, and an auxiliary AND gate 31 which supplies an auxiliary clock 18 to the auxiliary register 21.

The auxiliary AND gate 31 receives a write signal 11 and an auxiliary address signal 12, and computes the logical product of these two signals to output the resultant signal as the auxiliary clock 18. The auxiliary register 21 is a one-bit register which stores data 15 (i.e., a bit value) in response to receipt of the auxiliary clock 18. The auxiliary register 21 then outputs the bit value of the stored data as the gate signal 17.

The write AND gate 30 receives the gate signal 17, the write signal 11, and a write address signal 13, and computes the logical product of these three signals to output the resultant signal as the write clock 16. In response to receipt of the write clock 16, the data register 20 stores parallel data (a plurality of bits) transferred through the data bus 14. The data register 20 then outputs the stored parallel data (the plurality of bits) to the outside of the circuit block 100-x.

The number of bits of data stored in the data register 20 is less than or equal to the width (the number of bits) of the data bus 14. In the present embodiment, in order to simplify the explanation, it is assumed that the number of bits of the data stored in the data register 20 is equal to the width (the number of bits) of the data bus 14, both of which are 32 bits.

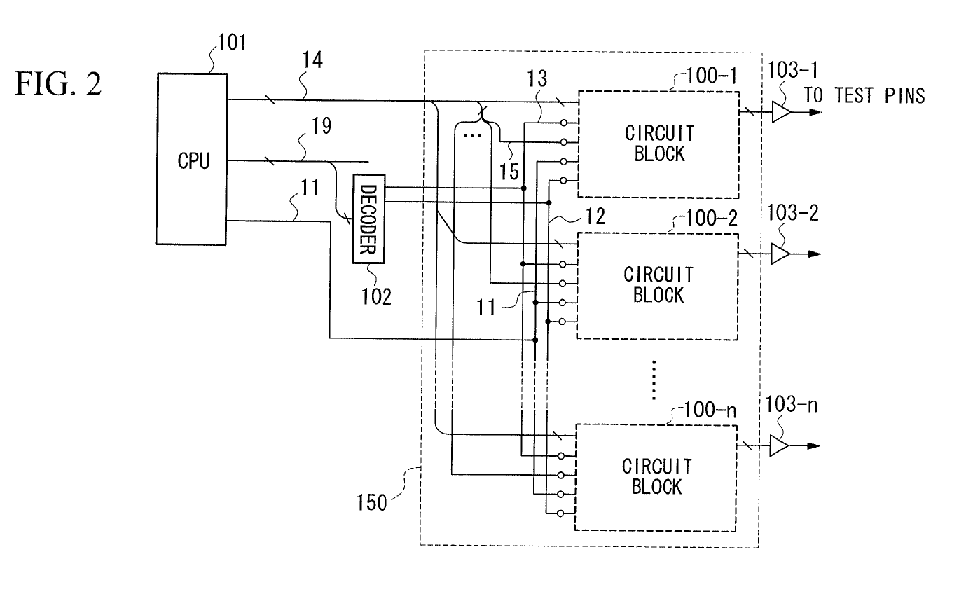

FIG. 2 is a block diagram showing the overall structure of a data transfer circuit 150 according to the present embodiment. The data transfer circuit 150 is provided with n (n is an integer greater than one) circuit blocks 100-1, 100-2, . . . , and 100-n, whose outputs are supplied to n (n is an integer greater than one) drivers 103-1, 103-2, . . . , and 103-n, respectively. The output of the drivers 103-1, 103-2, . . . , and 103-n are connected, for example, to test pins (not shown in the figures) of a semiconductor testing apparatus (not shown in the figures), and these test pins supply test signals to a semiconductor device under test (not shown in the figures) mounted in the semiconductor testing apparatus.

A CPU 101, which controls the overall operation of a system such as a semiconductor testing apparatus, is connected to the data bus 14, and outputs 32 bit parallel data to the data bus 14. The data bus 14 is also connected to the data registers 20 provided in the circuit blocks 100-1, 100-2, . . . , and 100-n. That is, each of the data registers 20 provided in the circuit blocks 100-1, 100-2, . . . , and 100-n receives 32 bit parallel data through the data bus 14.

Additionally, 32 data lines (32 bits) constituting the data bus 14 are connected to the auxiliary registers 21 provided in the circuit blocks 100-1, 100-2, . . . , and 100-n. That is, the respective bit values of parallel 32 bit data transferred through the data bus 14 are supplied to the corresponding auxiliary registers 21 provided in the circuit blocks 100-1, 100-2, . . . , and 100-n as the data 15. For example, bit 1 of the parallel 32 bit data transferred through the data bus 14 is supplied to the circuit block 100-1, and bit 2 of the parallel data is supplied to the circuit block 100-2.

The CPU 101 is also connected to the address bus 19 to output an address to the address bus 19. An address transferred through the address bus 19 is supplied to the decoder 102. The decoder 102 converts the supplied address into address signals. That is, the decoder 102 outputs only the auxiliary address signal 12, outputs only the write address signal 13, or outputs neither the auxiliary address signal 12 nor the write address signal 13, depending on the received address. More specifically, the decoder 102 outputs only the auxiliary address signal 12 when the received address is in the range allocated to auxiliary address signals. The decoder 102 outputs only the write address signal 13 when the received address is in the range allocated to write address signals. Otherwise, the decoder 102 outputs neither the auxiliary address signal 12 nor the write address signal 13.

The auxiliary address signal 12 output from the decoder 102 is supplied to the auxiliary AND gates 31 provided in the circuit blocks 100-1, 100-2, . . . , and 100-n. The write address signal 13 output from the decoder 102 is supplied to the write AND gates 30 provided in the circuit blocks 100-1, 100-2, . . . , and 100-n.

The CPU 101 also outputs the write signal 11 for directing the data registers or the auxiliary registers to store data therein. The write signal 11 is commonly supplied to the auxiliary AND gates 31 and the write AND gates 30 provided in the circuit blocks 100-1, 100-2, . . . , and 100-n.

Next, the operation of the present embodiment will be explained. First, the CPU 101 outputs an address in the range allocated to the auxiliary address signals to the address bus 19. The output address is supplied to the decoder 102, which outputs the auxiliary address signal 12. The auxiliary address signal 12 thus output is supplied to the auxiliary AND gates 31 provided in the circuit blocks 100-1, 100-2, . . . , and 100-n.

Subsequently, the CPU 101 outputs data 15, which is to be transferred to the auxiliary registers 21 provided in the circuit blocks 100-1, 100-2, . . . , and 100-n, to the data bus 14. The CPU 101 then outputs a pulse as the write signal 11. The output pulse of the write signal 11 is supplied to the auxiliary AND gates 31 provided in the circuit blocks 100-1, 100-2, . . . , and 100-n. Each auxiliary AND gate 31 outputs the auxiliary clock 18 to the corresponding auxiliary register 21. As a result, the corresponding auxiliary register 21 stores the data 15 transferred from the CPU 101 through the data bus 14. The auxiliary register 21 outputs the stored data as the gate signal 17, which is supplied to the write AND gate 30.

Next, the CPU 101 outputs an address in the range allocated to write address signals to the address bus 19. The output address is supplied to the decoder 102, which outputs a write address signal 13. The output write address signal 13 is supplied to the write AND gates 30 provided in the circuit blocks 100-1, 100-2, . . . , and 100-n.

When the CPU 101 outputs the write address to the address bus 19, the CPU 101 simultaneously outputs parallel 32 bit data, which is to written into each data register 20 provided in the circuit blocks 100-1, 100-2, . . . , and 100-n, to the data bus 14.

Next, the CPU 101 outputs a pulse as the write signal 11. The output pulse of the write signal 11 is supplied to the write AND gates 30 provided in the circuit blocks 100-1, 100-2, . . . , and 100-n. In the respective circuit blocks, if the gate signal 17 is high level, the write AND gate 30 outputs the write clock 16 to the data register 20. The data register 20 then stores one bit of the parallel 32 bit data transferred from the CPU 101 through the data bus 14. The parallel 32 bit data stored in the data registers 20 is output to the drivers 103-1, 103-2, . . . , and 103-n. The drivers 103-1, 103-2, . . . , and 103-n supply signals to test pins of a semiconductor testing apparatus in order to test a semiconductor device mounted in the semiconductor testing apparatus.

As described above, in the first step, among the n data registers 20 provided in the n circuit blocks, “1”s are written into the auxiliary registers 21 provided in the specific circuit blocks including the data registers 20 where identical data should be stored. Next, in the second step, parallel data transferred through the data bus 14 are simultaneously written into the data registers 20 provided in the specific circuit blocks where the parallel data should be stored. As a result, it is possible to reduce the number of times of that data transfer is carried out.

Incidentally, when the number of the circuit blocks n is greater than the width of the data bus 14 (e.g., 32 bits in the present embodiment), the above data transfer circuit is configured such that the decoder 102 outputs a plurality of auxiliary address signals 12 sequentially, and for respective auxiliary address signals 12, identical data is written into the auxiliary registers 21 corresponding to the given auxiliary address signal 12. In this case, the number of the auxiliary address signals 12 is equal to the minimum integer which is no less than the value n/32.

Second Embodiment

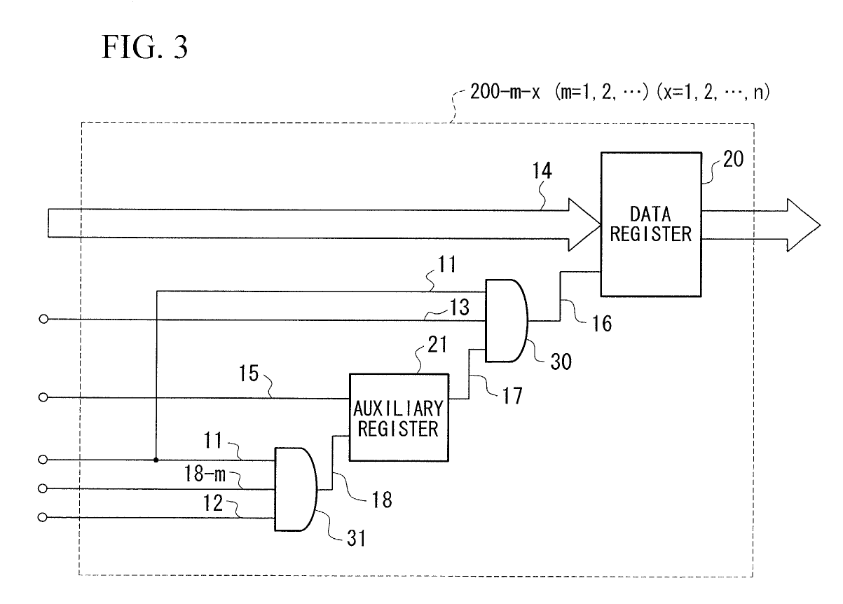

FIG. 3 is a block diagram showing the structure of one of circuit blocks 200-m-x (m=1, 2, . . . , and x=1, 2, . . . , n (n is an integer greater than one)) constituting a data transfer circuit according to a second embodiment of the present invention. The difference between the circuit block 200-m-x of the present embodiment and the circuit block 100-x according to the first embodiment is that a block cell signal 18-m (m=1, 2, . . . ) is supplied to the auxiliary AND gate 31.

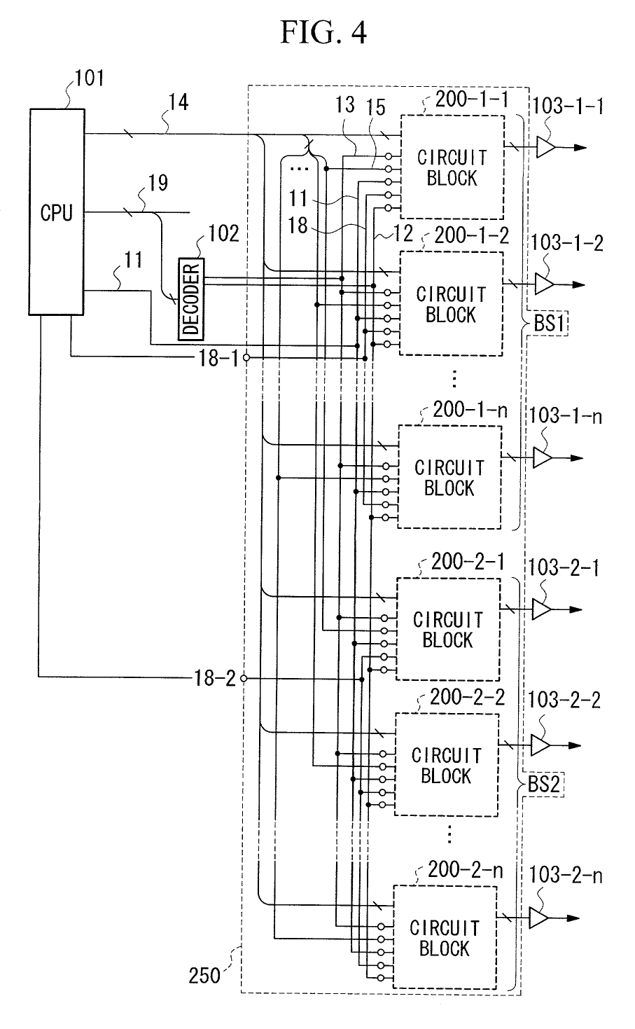

FIG. 4 is a block diagram showing the overall structure of a data transfer circuit 250 according to the second embodiment. The difference between the data transfer circuit 250 according to the present embodiment and the data transfer circuit 150 according to the first embodiment is that the circuit blocks are divided into a plurality of block cells. In the present embodiment, 2n circuit blocks are divided into two block cells BS1 and BS2. In addition, block cell signals 18-1 and 18-2 for respectively selecting the block cells BS1 and BS2 are supplied to the data transfer circuit 250. These block cell signals are supplied from the CPU 101.

When the block cell signal 18-1 is set to high level, the block cell BS1 is selected and parallel 32 bit data is stored in the data registers 20 of the circuit blocks provided in the block cell BS1. Similarly, when the block cell signal 18-2 is set to high level, the block cell BS2 is selected, and parallel 32 bit data is stored in the data registers 20 of the circuit blocks provided in the block cell BS2.

A pattern of test signals output from one of the block cells is identical to a pattern of test signals output from another block cell. In other words, the data stored in the data register 20 provided in a circuit block in one of the block cells is identical to the data stored in the data register 20 provided in the corresponding circuit block in another block cell. For example, the data stored in the data register 20 provided in the circuit block 200-1-1 in the block cell BS1 is identical to the data stored in the data register 20 provided in the circuit block 200-2-1 in the block cell BS2. Similarly, the data stored in the circuit block 200-1-2 in the block cell BS1 is identical to the data stored in the circuit block 200-2-2 in the block cell BS2.

According to the present embodiment, identical data 15 is simultaneously written into the auxiliary registers 21 provided in the corresponding circuit blocks in the block cells. Therefore, it is not necessary to sequentially transfer the data 15 for respective block cells. That is, it is possible to simultaneously transfer the data 15 to the auxiliary registers 21 provided in the block cells.

In addition, according to the present embodiment, it is possible to control whether to perform data transfer for respective block cells by setting the levels of the block cell signals 18-1 and 18-2 separately.

Incidentally, while it is assumed that the data registers are provided in the data transfer circuits in the above embodiments, they may also be provided outside of the data transfer circuits.

What is claimed is:

1. A data transfer circuit for transferring first parallel data transferred through a data bus to a plurality of data registers, comprising:
a plurality of auxiliary registers, each of which corresponds to each of the data registers and stores a bit value indicating whether the first parallel data transferred through the data bus is to be stored in the corresponding data register;
an auxiliary register setting section which writes, at a first timing, the respective bit values of second parallel data transferred through the data bus that correspond to the respective auxiliary registers into the respective auxiliary registers; and
a write timing determining section which writes, at a second timing, after the first timing, the first parallel data transferred through the data bus into data registers corresponding to auxiliary registers, each of which stores a bit value indicating that the first parallel data is to be stored in the corresponding data register.

2. A data transfer circuit according to claim 1, wherein the data registers are divided into a plurality of block cells, and the auxiliary register setting section determines whether to write the respective bit values of the second parallel data into the respective auxiliary registers for each block cell.

3. A data transfer method for transferring first parallel data transferred through a data bus to a plurality of data registers, comprising the steps of:
a first step for writing, at a first timing, the respective bit values of second parallel data, which is transferred through the data bus and indicates whether the first parallel data is to be stored in the data registers, into a plurality of auxiliary registers corresponding to the respective data registers; and
a second step for writing, at a second timing, after the first timing, the first parallel data transferred through the data bus into data registers corresponding to auxiliary registers, each of which stores a bit value indicating that the first parallel data is to be stored in the corresponding data register, by means of a write timing determining section.

4. A data transfer method according to claim 3, wherein the data registers are divided into a plurality of block cells, and the first step determines whether to write the respective bit values of the second parallel data into the respective auxiliary registers for each block cell.
